(19) United States
(12) Patent Application Publication
(10) Pub. No.: US 2019/0330855 A1
(43) Pub. Date: Oct. 31, 2019

(54) SCREW-IN BACK BOLT AND METHOD FOR INSTALLING CURTAIN WALL AND PANEL THEREWITH

(71) Applicant: TOPIN (SHANGHAI) INTERNATIONAL TRADER CO., LTD., Shanghai (CN)

(72) Inventor: Li Liu, Shanghai (CN)

(21) Appl. No.: 16/505,683

(22) Filed: Jul. 8, 2019

Related U.S. Application Data
(63) Continuation of application No. PCT/CN2017/087885, filed on Jun. 12, 2017.

(30) Foreign Application Priority Data
Jan. 19, 2017 (CN) 201710046623.6

(51) Int. Cl. E04F 13/08; F16B 13/06

(52) U.S. Cl. CPC E04F 13/0835; E04B 2/90; F16B 13/06

(57) ABSTRACT

A screw-in back bolt comprises a back bolt sleeve and a limit screw. A front end of the back bolt sleeve is an expandable portion that can be expanded by the limit screw. The limit screw (3) can be screwed in from a rear end of the anchor bolt sleeve until the limit screw is secured in place. The expandable portion of the back bolt sleeve (2) is provided with one or more conical surfaces. A method for installing a panel based on the screw-in back bolt comprises: drilling an back bolt hole in a back of the panel; injecting an adhesive into the back bolt hole; placing the back bolt sleeve into the back bolt hole; and screwing the limit screw into the back bolt sleeve to expand the anchor bolt sleeve. A curtain wall comprises the panel and the screw-in anchor bolt.

### CROSS-REFERENCE TO RELATED APPLICATIONS

This application is a continuation of International Patent Application No. PCT/CN2017/087885 with a filing date of Jun. 12, 2017, designating the United States, now pending, and further claims priority to Chinese Patent Application No. 201710046623.6 with a filing date of Jan. 19, 2017. The content of the aforementioned applications, including any intervening amendments thereto, are incorporated herein by reference.

### TECHNICAL FIELD

The present disclosure relates to the field of back bolts, particularly relates to a screw-in back bolt and a method for installing a curtain wall and a panel therewith, and more particularly relates to a double-conical-surface screw-in back bolt.

### BACKGROUND OF THE PRESENT INVENTION

In the prior art, there are generally two manners in order to achieve the installation of a curtain wall. One manner is that a panel is adhered using the adhesive, and in this manner, all bearing forces of the panel are from viscous forces of the adhesive, which is not beneficial to long-time dry hanging of the panel, and is complicated in construction. The other manner is to adopt an expandable anchor bolt which is an anchor bolt utilizing an expandable member to extrude the hole wall of the anchor hole to form an anchoring effect, and is an assembly which utilizes the opposite movement of a conical body relative to the expandable sheet to promote the expansion of the expandable sheet to generate an expansion pressure with the hole wall panel and generate a pulling-resistant force through a shearing friction effect to anchor the connected member. However, this manner causes stress concentration inside the panel so as to increase the burden on a panel structure strength requirement and it is incapable of installing an ultra-thin panel.

### SUMMARY OF PRESENT INVENTION

A method for installing a panel based on a screw-in back bolt provided according to the disclosure includes: step A: drilling an anchor bolt hole in the back of a panel; step B: injecting an adhesive into the anchor bolt hole; step C: placing an back bolt sleeve of the back bolt into the anchor bolt hole; and step D: screwing a limit screw of the back bolt into the back bolt sleeve so that the back bolt sleeve is spread.

Preferably, the step A includes: step A1: drilling a straight hole in the back of the panel; and step A2: expanding the bottom of the straight hole into a counterbore, wherein, the counterbore has a pressure-bearing surface capable of locking the spread back bolt sleeve in an axial direction.

Preferably, the counterbore is only capable of locking the spread back bolt sleeve in an axial direction.

Preferably, the step B includes: step B1: injecting the adhesive into the anchor bolt hole, the injection amount meets: the adhesive is capable of filling all or partial anchor bolt holes after the back bolt is spread, and the adhesive includes an epoxy resin AB adhesive.

Preferably, the step C includes: step C1: pushing the back bolt sleeve of the back bolt into the anchor bolt hole until the front end of the back bolt sleeve is abutted against the hole bottom of the anchor bolt hole, wherein, before spread, a maximal diameter of the back bolt sleeve is smaller than a minimal diameter of the anchor bolt hole.

Preferably, the step D includes: step D1: screwing a limit screw in place, wherein, screwing the limit screw in place means that the front part of the back bolt sleeve is spread until being locked by the pressure-bearing surface of the counterbore in an axial direction, and the back bolt sleeve is capable of freely rotating in the anchor bolt hole.

Preferably, the method for installing a panel based on a screw-in back bolt includes: step E: screwing a slip preventing nut on the limit screw to lock a metal suspender.

A screw-in back bolt provided according to the disclosure includes a back bolt sleeve and a limit screw; the front part of the back bolt sleeve is an expandable portion capable of being spread by the limit screw; the limit screw is capable of being screwed in from the rear end of the back bolt until the limit screw is locked; and the expandable portion of the back bolt sleeve is provided with one or more conical surfaces.

The disclosure provides a curtain wall installed by adopting the method for installing a panel based on the screw-in back bolt.

The disclosure provides a curtain wall, including a panel and the above screw-in back bolt; an anchor bolt hole is drilled in the back of the panel, the back bolt sleeve of the screw-in back bolt is located in the anchor bolt hole, and the back bolt sleeve is spread by the screwed limit screw; the spread back bolt sleeve is locked by the anchor bolt hole in an axial direction; and the back bolt sleeve is firmly connected with the anchor bolt hole through the adhesive in circumferential and radial directions.

Aiming at the defects in the prior art, the objective of the disclosure is to provide a screw-in back bolt and a method for installing a panel.

Compared with the prior art, the disclosure has the following beneficial effects:

1. The disclosure combines mechanical locking and chemical adhesion, so as to greatly improve the installation structure strength of the panel, and installation is simple and safe.

2. The disclosure is suitable for multiple curtain wall panel materials and can be applied to a 9 mm board, more use of thin boards saves the expense of the expansive board material and even reduces material drawing limitation due to high building structure requirement.

3. In the disclosure, a completely matched back bolt is adopted in the counterbore spread at the bottom of the anchor bolt hole, so that a sufficiently strong support force can be achieved, and the panel has no any internal stress, thereby reducing the damage rate of the panel.

### DESCRIPTION OF THE DRAWINGS

Other features, objectives and advantages of the disclosure will become more apparent by referring to detailed description of non-limiting embodiments made according to the following accompanying drawings.

FIG. 1 is a structural diagram of an installed back bolt. O represents a length of an exposed limit screw.

FIG. 2 is an exploded view of a component in FIG. 1. D represents a length of a back bolt sleeve in an axial direction. S represents a length of a limit screw.

FIG. 3 is a structural diagram of an installed back bolt.

FIG. 4 is a structural diagram of an installed back bolt.

FIG. 5 is an exploded view of a component in FIG. 4.

FIG. 6 is a structural diagram of a back bolt sleeve before being spread.

In the drawings:

1—panel

101—straight hole section

102—counterbore section

103—pressure-bearing surface

2—back bolt sleeve

201—first conical surface

202—second conical surface

3—limit screw

301—positioning line (also referred to as a limit line)

4—installation bracket (also referred to as a suspender)

5—slip preventing nut

6—adhesive

### DETAILED DESCRIPTION OF PREFERRED EMBODIMENTS

The disclosure will be described in detail in combination with embodiments. The following examples will help those skilled in the art to understand the disclosure, but does not limit the disclosure in any form. It should be noted that for one of ordinary skill in the art, several changes and modifications can also be made without breaking away from conception of the disclosure. These all belong to the protection scope of the disclosure.

The disclosure provides a screw-in back bolt, also provides a method for installing a panel based on the screw-in back bolt, and further provides a curtain wall based on the screw-in back bolt and utilizing the installation method. In the following, the disclosure will be described in detail.

The disclosure provides a method for installing a panel based on a screw-in back bolt, including:

Step A: drilling an anchor bolt hole in the back of a panel;

Step B: injecting an adhesive into the anchor bolt hole;

Step C: placing a back bolt sleeve of the back bolt into the anchor bolt hole;

Step D: screwing a limit screw of the back bolt into the back bolt sleeve so that the back bolt sleeve is spread; and

Step E: screwing a slip preventing nut on the limit screw to lock a metal suspender.

The step A includes: step A1: drilling a straight hole in the back of the panel; and step A2: expanding the bottom of the straight hole into a counterbore, wherein, the counterbore has a pressure-bearing surface capable of locking the spread back bolt sleeve in an axial direction.

Preferably, the counterbore is only capable of locking the spread back bolt sleeve in an axial direction.

The step B includes: step B1: injecting the adhesive into the anchor bolt hole, wherein, the injection amount meets: the adhesive is capable of filling all or partial anchor bolt holes after the back bolt is spread. Preferably, the adhesive can be an epoxy resin AB adhesive (high-elasticity 6101 and 618 series are preferably used). During the epoxy time of the adhesive, the back bolt sleeve is installed and the limit screw is installed in place. The adhesive can be injected into a position which is 50% of the depth of the anchor bolt hole. When the limit screw is installed in the back bolt sleeve, the epoxy adhesive fills all the holes in the anchor bolt holes so as to ensure that all the back bolts on the panel are effective and stressed, thereby reducing the dropping risk of the panel to zero.

The step C includes: step C1: pushing the back bolt sleeve of the back bolt into the anchor bolt hole until the front end of the back bolt sleeve is abutted against the hole bottom of the anchor bolt hole, wherein, before spread, a maximal diameter of the back bolt sleeve is smaller than a minimal diameter of the anchor bolt hole. The back bolt sleeve can be all or partially embedded into the anchor bolt hole.

The step D includes: step D1: screwing a limit screw in place, wherein, screwing the limit screw in place means that the front part of the back bolt sleeve is spread until being locked by the pressure-bearing surface of the counterbore in an axial direction, and the back bolt sleeve is capable of freely rotating in the anchor bolt hole. Preferably, the limit screw is provided with a limit line, when the limit line is parallel to the hole mouth of the anchor bolt hole or the back end surface of the anchor bolt hole, the limit screw is right screwed in place. Through the continuous rotation of the limit screw, the limit screw is screwed into the back bolt sleeve in the panel layer by layer. When being rotated in place according to indication of the limit line, the limit screw is installed in place. The rotation torsion in the whole process is only 12N m/s. After installation, before the adhesive is solidified, the back bolt can be freely rotated in the anchor bolt hole of the panel without stress concentration on the inside of the panel.

The disclosure provides a screw-in back bolt, including a back bolt sleeve and a limit screw. The front part of the anchor bolt sleeve is an expandable portion capable of is spread by the limit screw; the limit screw is screwed in from the rear end of the back bolt sleeve; when the expandable portion is not spread, the outer diameter of the expandable portion is smaller than that of the rear of the back bolt sleeve.

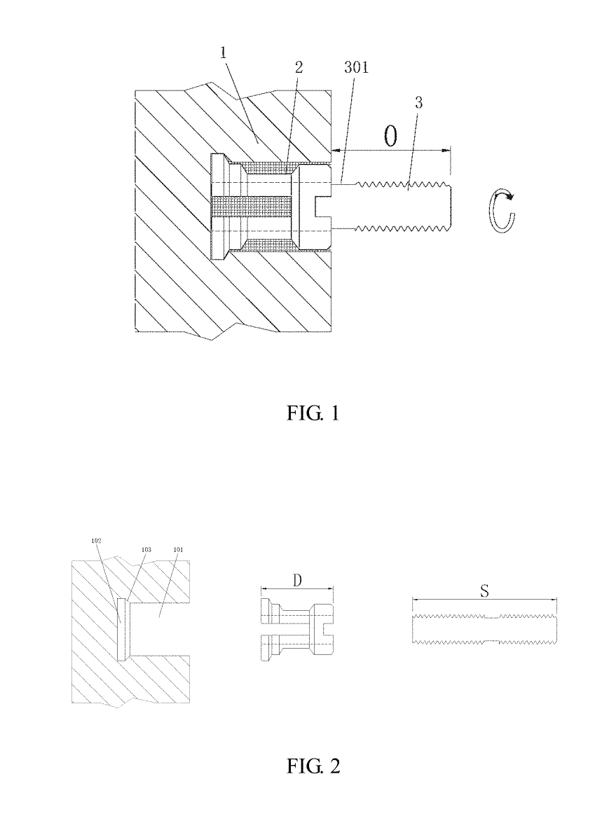

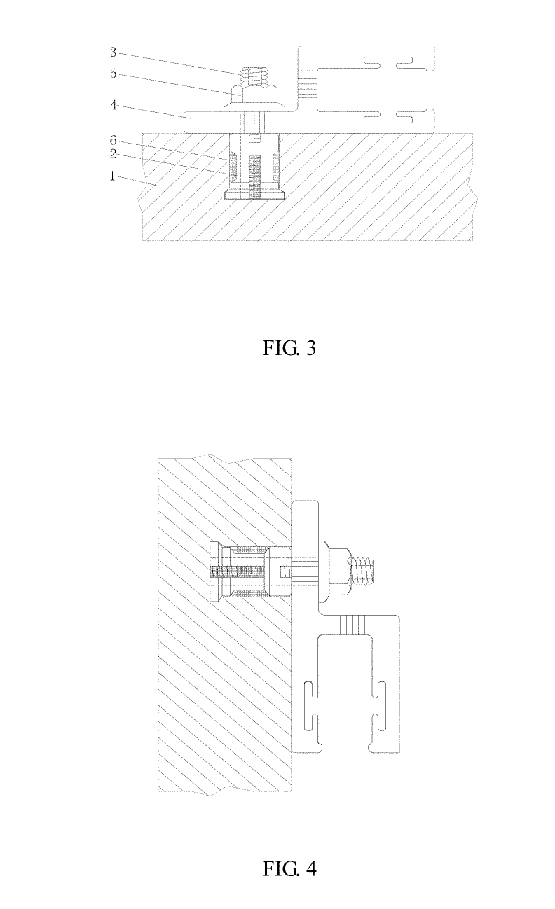

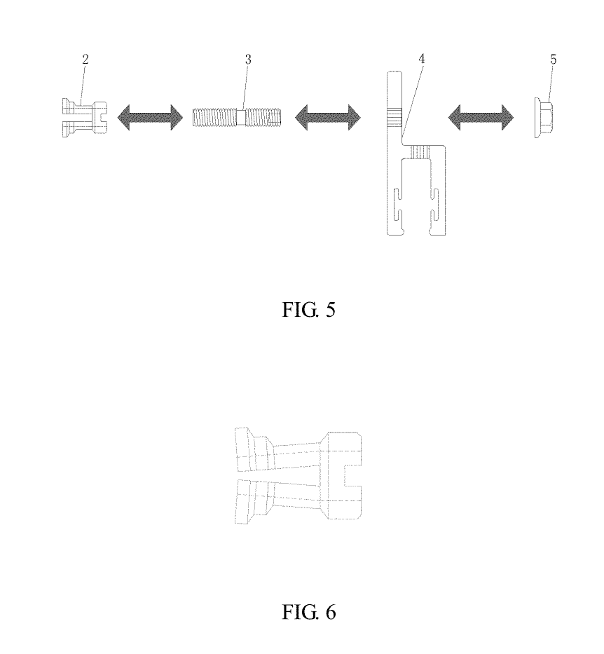

As shown in FIG. 1, the expandable portion of the back bolt sleeve is provided with more conical surfaces, respectively denoted as a first conical surface and a second conical surface, wherein, the conical surface is of a local side shape of a frustum. Further particularly, the first conical surface is matched with the pressure-bearing surface of the counterbore, namely, the first conical surface is clamped inside the pressure-bearing surface, so that the back bolt sleeve cannot be pulled out from the counterbore; the second conical surface is matched with the adhesive, so as to greatly improve the strength of the screw-in back bolt.

The disclosure provides a curtain wall. The curtain wall is installed by adopting the method for installing a panel based on the screw-in back bolt.

The disclosure provides a curtain wall, including a panel and the above screw-in back bolt; an anchor bolt hole is drilled in the back of the panel, the back bolt sleeve of the screw-in back bolt is located in the anchor bolt hole, and the back bolt sleeve is spread by the screwed limit screw; the spread back bolt sleeve is locked by the anchor bolt hole in an axial direction; the back bolt sleeve is firmly connected with the anchor bolt hole through the adhesive in circumferential and radial directions.

The above contents are description of embodiments of the disclosure. It should be understood that the invention is not limited to the above specific embodiments, those skilled in the art can make various changes or modifications within the scope of the claims, which does not influence the substantial content of the disclosure. In case without conflict, embodiments of the present application and features in embodiments can be mutually combined randomly.

I claim:

1. A method for installing a panel based on a screw-in back bolt, comprising:
step A: drilling an anchor bolt hole in a back of the panel;
step B: injecting an adhesive into the anchor bolt hole;
step C: placing an back bolt sleeve of the back bolt into the anchor bolt hole; and
step D: screwing a limit screw of the back bolt into the back bolt sleeve so that the back bolt sleeve is spread.

2. The method according to claim 1, wherein, the step A comprises:
step A1: drilling a straight hole in the back of the panel; and
step A2: expanding a bottom of the straight hole into a counterbore, wherein, the counterbore has a pressure-bearing surface capable of locking the spread back bolt sleeve in an axial direction.

3. The method according to claim 2, wherein, the counterbore is only capable of locking the spread back bolt sleeve in an axial direction.

4. The method according to claim 1, wherein, the step B comprises:
step B1: injecting the adhesive into the anchor bolt hole, wherein, an injection amount meets: the adhesive is capable of filling all or partial anchor bolt holes after the back bolt is spread; and the adhesive comprises an epoxy resin AB adhesive.

5. The method according to claim 1, wherein, the step C comprises:
step C1: pushing the back bolt sleeve of the back bolt into the anchor bolt hole until a front end of the back bolt sleeve is abutted against the hole bottom of the anchor bolt hole;
wherein, before spread, a maximal diameter of the anchor bolt sleeve is smaller than a minimal diameter of the anchor bolt hole.

6. The method according to claim 2, wherein, the step D comprises:
step D1: screwing a limit screw in place, wherein, screwing the limit screw in place means that the front part of the back bolt sleeve is spread until being locked by the pressure-bearing surface of the counterbore in an axial direction, and the back bolt sleeve is capable of freely rotating in the anchor bolt hole.

7. The method according to claim 1, comprising:
step E: screwing a slip preventing nut on the limit screw to lock a metal suspender.

8. A screw-in back bolt, comprising a back bolt sleeve and a limit screw;
wherein a front part of the back bolt sleeve is an expandable portion capable of being spread by the limit screw;
the limit screw is capable of being screwed in from a rear end of the back bolt until the limit screw is locked; and
the expandable portion of the back bolt sleeve is provided with one or more conical surfaces.

9. A curtain wall installed by using the method according to claim 1.

10. A curtain wall, comprising a panel and the screw-in back bolt according to claim 8;
wherein an anchor bolt hole is drilled in a back of the panel, the back bolt sleeve of the screw-in back bolt is located in an anchor bolt hole, and the back bolt sleeve is spread by the screw-in limit screw;
the spread back bolt sleeve is locked by the anchor bolt hole in an axial direction; and
the back bolt sleeve is firmly connected with the anchor bolt hole through an adhesive in circumferential and radial directions.
